(19) United States
(12) Patent Application Publication
(10) Pub. No.: US 2017/0240660 A1
(43) Pub. Date: Aug. 24, 2017

(54) USING ORGANIC PHOTOREDOX CATALYSTS TO ACHIEVE METAL FREE PHOTOREGULATED CONTROLLED RADICAL POLYMERIZATION

(71) Applicants: DOW GLOBAL TECHNOLOGIES LLC, Midland, MI (US); THE REGENTS OF THE UNIVERSITY OF CALIFORNIA, Oakland, CA (US)

(72) Inventors: John W. KRAMER, Midland, MI (US); Craig J. HAWKER, Santa Barbara, CA (US); Brett P. FORS, Goleta, CA (US); Nicolas J. TREAT, Goleta, CA (US); Hazel SPRAFKE, Santa Barbara, CA (US); Paul G. CLARK, Midland, MI (US); Javier READ de ALANIZ, Santa Barbara, CA (US)

(21) Appl. No.: 15/514,752

(22) PCT Filed: Oct. 6, 2015
(86) PCT No.: PCT/US2015/054196

§ 371 Date: Mar. 27, 2017

Related U.S. Application Data
(60) Provisional application No. 62/060,414, filed on Oct. 6, 2014.

(51) Int. Cl. C08F 2/50; C08F 4/40

(52) U.S. Cl. CPC C08F 2/50; C08F 4/40

(57) ABSTRACT

Disclosed are methods for controlled radical polymerization of acrylic monomers using an organic photoredox catalyst, where the polymerization is mediated, as well as regulated, by light.

### CROSS-REFERENCE TO RELATED APPLICATIONS

This application claims priority to U.S. Provisional Application No. 62/060,414, filed Oct. 6, 2014, the disclosure of which is hereby incorporated by reference in its entirety.

### BACKGROUND OF THE INVENTION

Field of the Invention

The disclosure provides methods for controlled radical polymerization of acrylic and/or styrenic monomers using an organic photoredox catalyst, where the polymerization is mediated, as well as regulated, by light.

Description of the Related Art

Controlled radical polymerizations (CRP), such as nitroxide mediated polymerization (NMP), reversible-addition fragmentation chain transfer polymerization (RAFT), and atom transfer radical polymerization (ATRP), have revolutionized the field of polymer chemistry, allowing for the synthesis of well-defined macromolecular structures with excellent functional group tolerance. Perhaps of greater importance is the facile nature of the process and mild reaction conditions which allows non-experts access to functional materials. More recently, additional control over living radical polymerizations has been achieved through regulation of the chain growth process by an external stimulus. This auxiliary control is a major advance for the field and the potential for further innovation is significant. For example, electrochemical ATRP has been used to pattern polymer brushes on surfaces, as well as gain control over aqueous polymerizations.

Understandably, there have been a number of efforts to increase the technical applicability of polymerization processes, for example through strategies to regulate the activation and deactivation steps by using an external stimulus. In considering the wide range of possible external stimuli, light offers many attractive features such as readily available light sources, facile use and both spatial and temporal control. On this basis, significant work has been dedicated to the development of photoinitiated and photoregulated radical polymerizations (i.e., photocontrolled RAFT, ATRP, organocatalytic, cobalt-mediated, and tellurium-mediated methods). A photocontrolled radical polymerization of methacrylates and acrylates catalyzed by an Ir-based photoredox catalyst has also been disclosed. However, the use of the expensive Ir-based catalyst limited the practicality of this system, as well as its use in a number of applications, such as electronic materials. On this basis, the ability to perform these photocontrolled radical polymerizations in the absence of even parts per million (ppm) metals would extend the scope of this process to a variety of applications, as well as render the process more economically feasible.

### SUMMARY OF THE INVENTION

The method of the disclosure provides ability to precisely control the molecular weight and molecular weight distributions, as well as gain sequence and architecture control in polymer synthesis. In a broad aspect, the methods of the disclosure provide a controlled, light mediated radical polymerization of a variety of monomers using an organic photoredox catalyst. The polymerization methods of the disclosure provide efficient activation and deactivation by light, with no polymerization observed in the dark, and rapid reactivation occurring upon re-exposure to light. The organic photoredox catalysts of the disclosure advantageously offer greater monomer tolerance then the transition metal-based system. Further, the methods of the disclosure allow for the synthesis of block copolymers, as well as the ability to be combined with other polymerization methods to make well-defined materials.

In one aspect, the disclosure provides methods for preparing a polymer composition, comprising:
combining one or more (meth)acrylate, (meth)acrylamide, (meth)acrylonitrile, styrene, acrylonitrile, vinyl acetate, vinylcarbazole, vinylpyridine, and vinyl chloride monomers with an initiator and an organic photoredox catalyst to obtain a reaction mixture; and
polymerizing the monomers by irradiating the reaction mixture with a light source;
wherein the organic photoredox catalyst is reducing in an excited state.

In another aspect, the disclosure provides methods for preparing a polymer composition of formula I:

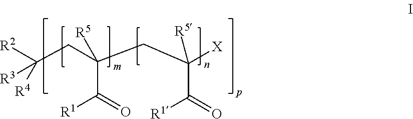

wherein
m and n are independently an integer about 3 to about 1500;
is an integer of 1 to 6;
X is a halogen, xanthate, dithioester, trithiocarbonate, dithiocarbamate, or nitroxide;
each R¹ and R¹′ is independently —OH, C₁-C₂) alkoxy, amino, mono or di(C₁-C₂₀ alkylamino, aryloxy, or alkoxyaryl, wherein each alkyl or aryl group is optionally substituted with one or more groups that are independently C₁-C₆ alkyl, C₁-C₆ alkoxy, halogen, hydroxy, amino, mono- or di-(C₁-C₆) alkylamino, halo(C₁-C₆)alkyl, or halo(C₁-C₆)alkoxy;
R² is —CN, —CH=CH₂, —C(O)C₁-C₆ alkoxy, —COOH, —(CH₂)₁₋₂C(O)C₁-C₆ alkoxy, —(CH₂)₁₋₂COOH, —(CH₂)₁₋₃C₁-C₆ alkoxy, —(CH₂)₁₋₃OH, C₁-C₆ alkyl, aryl, or heteroaryl;
R³ and R⁴ are independently selected from hydrogen, —ON, C₁-C₆ alkyl, and phenyl; and each R⁵ and R⁵′ is independently is H or methyl;
the method comprising:
combining one or more of monomers with an initiator and an organic photoredox catalyst to obtain a reaction mixture; and
polymerizing the monomers by irradiating the reaction mixture with a light source;
wherein the organic photoredox catalyst is reducing in an excited state.

In certain aspect, the disclosure provides methods for preparing a polymer of a predetermined molecular weight and polydispersities. In other certain aspects, the disclosure provides methods for preparing a polymer having selected lengths and/or selected molecular weights and/or selected molecular weight distributions and/or selected architectures. In other certain aspects, the disclosure provides methods for preparing a polymer having a polydispersity index between about 1.0 and about 2.5. In other certain aspects, the disclosure provides methods for preparing a polymer having a polydispersity index of greater than 2.0. These methods comprise the steps as described above.

In certain aspect, the disclosure provides methods for preparing an acrylic and/or styrenic polymer of a predetermined molecular weight and polydispersities. In other certain aspects, the disclosure provides methods for preparing an acrylic and/or styrenic polymer having selected lengths and/or selected molecular weights and/or selected molecular weight distributions and/or selected architectures. In other certain aspects, the disclosure provides methods for preparing an acrylic and/or styrenic polymer having a polydispersity index between about 1.0 and about 2.5. In other certain aspects, the disclosure provides methods for preparing an acrylic and/or styrenic polymer having a polydispersity index of greater than 2.0, These methods comprise the steps as described above.

### BRIEF DESCRIPTION OF THE DRAWINGS

FIG. 1 illustrates polymerization of benzyl methacrylate (BnMA) using 10-phenylphenothiazine (PTH) while cycling the reactions exposure to light, and monitoring (a) conversion rate; (b) molecular weight vs, conversion, and (c) radical concentration. The experimental procedure is described in Example 3.

FIG. 2 shows ESI-MS of poly(methyl methacrylate) (PMMA) produced under the reaction conditions of the disclosure with the major peak blown up (inset) to indicate bromine isotopic splitting.

FIG. 3 illustrates block copolymer synthesis with SEC traces (the trace at the right of each graphs represents results for homopolymer, and the trace at the left of each graph represents results for block copolymer) (a) PMMA-b-PBnMA; (b) PMMA-b-PMA; and (c) PtBuMA-b-PDMAEMA.

FIG. 4 illustrates 20 μm×200 μm PMMA patterning with a photomask.

FIG. 5 provides a scheme with the proposed mechanism and necessary attributes for organocatalyzed photoredox polymerizations.

### DETAILED DESCRIPTION OF THE INVENTION

Before the disclosed methods and materials are described, it is to be understood that the aspects described herein are not limited to specific embodiments, methods, apparati, or configurations, and as such can, of course, vary. It is also to be understood that the terminology used herein is for the purpose of describing particular aspects only and, unless specifically defined herein, is not intended to be limiting.

In view of the present disclosure, the methods described herein can be configured by the person of ordinary skill in the art to meet the desired need. In general, the disclosed methods provide improvements in the polymerization of polymer compositions with efficient activation and deactivation of polymerization with control over molecular weight and molecular weight distributions by only using an organic (i.e., non-transition metal) catalyst. A fundamental advantage of this process is also that, in the absence of irradiation, the chain end rests as the dormant alkyl bromide, protected from deleterious radical reactions but available for reactivation upon re-exposure to light. As a result, the methods of the disclosure provide improved efficient chain capping and re-initiation of polymerization. The organic photoredox catalysts of the disclosure advantageously offer greater monomer tolerance then the transition metal-based system. Further, the methods of the disclosure allow for the synthesis of block copolymers, as well as the ability to be combined with other polymerization methods to make well-defined materials.

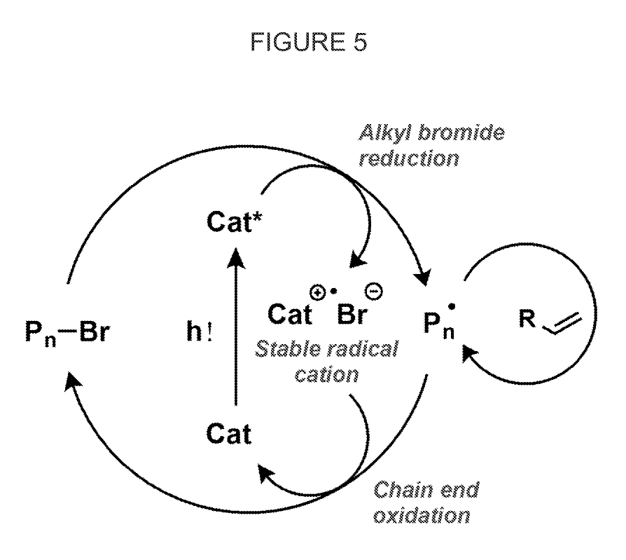

Although the emergent field of photoredox catalysis has primarily utilized transition metals (i.e. Iridium and Ruthenium), the use of organic catalysts to undergo useful transformations is also known. But, majority of these catalysts have been used as electron acceptors through a reductive quenching of the excited state. In the processes of the disclosure, a catalyst that can undergo oxidative quenching (electron donor) is needed in order to gain control over the chain-growth process, as illustrated in FIG. 5. Therefore, the disclosure provides methods of preparing polymer compositions by combining one or more monomers with an initiator and an organic photoredox catalyst that is reducing in an excited state. By the term “reducing in an excited state” is meant a catalyst that is capable of a single electron transfer event in an excited state, whereby an electron is donated from the catalyst to a substrate. Excited state reduction potential may be estimated by the following equation:

E_{1/2}*=E^{OX}−E_{0,0}

where E_{0,0} is estimated from the catalyst's emission onset in the following equation:

E_{0,0}=h×c/λₒₙₛₑₜ

where h is Planck's constant and c is the speed of light. In one embodiment, the catalyst that is reducing in an excited state stabilizes the radical cation species in an excited state.

For example, in certain embodiments, the organic photoredox catalyst may be selected from a phenothiazine derivative, a phenoxazine derivative, a 9,10-dihydroacridine derivative, a carbazole derivative, aryl amine derivatives, diaryl amine derivatives, triaryl amine derivatives, and large pi-extended all carbon derivate such as, but not limited to, rubrene, pyrene graphene, and carbon nanotubes.

In certain other embodiments (e.g., Embodiment 1), the organic photoredox catalyst has the formula A-Z, wherein

each A is independently:

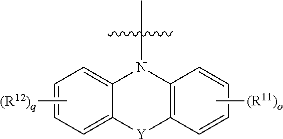

wherein

each Y is independently a bond, O, S, NR¹⁴, or C(R¹⁴)₂;

o and q are independently zero or an integer of 1 to 4;

R¹¹ and R¹² are independently selected from the group consisting of: halogen, cyano, hydroxy, amino, mono or di(C₁-C₂₀)alkylamino, mono or diarylamino, C₁-C₆ alkyl, halo(C₁-C₆)alkyl, C₁-C₆ alkoxy, halo(C₁-C₆)alkoxy, C₃-C₇ cycloalkyl, aryl, aryloxy, alkoxyaryl, and heteroaryl, wherein each alkyl, cycloalkyl, aryl, and heteroaryl group is optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy;

each R¹⁴ is independently hydrogen, C₁-C₆ alkyl, aryl, or aryl(C₁-C₆ alkyl), wherein each alkyl and aryl group is optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy; and each Z is R¹³, —B-(A)₂, —B—(R¹³)₂, —B(A)(R¹³), —NH-(A), —N-(A)₂, —NH—(R¹³), —N—(R¹³)₂, —N(A)(R¹³), —Si—(R¹³)₃, —SiH(R¹³)₂, —SiH₂(R¹³), —SiH(A)₂, —SiH₂(A), —Si(A)₃, —Si(A)₂(R¹³), —Si(A)(R¹³)₂, —SiH(A)(R¹³), —PH₂, —P-(A)₂, —P—(R¹³)₂, —P(R¹³)(A), or —P(O)—(OR¹³)₂, wherein

R¹³ is H, C₁-C₂₀ alkyl, —C(O)C₁-C₂₀ alkyl, C₃-C₇ cycloalkyl, aryl, aryl(C₁-C₆ alkyl), heteroaryl, or heteroaryl(C₁-C₆ alkyl), wherein each alkyl, cycloalkyl, aryl, and heteroaryl group is optionally substituted with one or more groups independently selected from C₁-C₆ alkyl, C₁-C₆ alkoxy, halogen, hydroxy, amino, mono- or di- (C₁-C₆) alkylamino, halo(C₁-C₆)alkyl, halo(C₁-C₆)alkoxy, C₃-C₇ cycloalkyl, aryl, aryloxy, alkoxyaryl, heteroaryl, heteroaryloxy, or group A.

Embodiment 2 encompasses photoredox catalysts of Embodiment 1 wherein each Z is R¹³, —B-(A)₂, —B—(R¹³)₂, —B(A)(R¹³), —NH-(A), —N-(A)₂, —NH—(R¹³), —N—(R¹³)₂, —N(A)(R¹³), —Si—(R¹³)₃, —SiH(R¹³)₂, —SiH₂(R¹³), —SiH(A)₂, —SiH₂(A), —Si(A)₃, —Si(A)₂(R¹³), —Si(A)(R¹³)₂, or —SiH(A)(R¹³). Particularly in Embodiment 2, each Z is R¹³, —B—(R¹³)₂, —NH—(R¹³), —N—(R¹³)₂, —Si—(R¹³)₃, —SiH(R¹³)₂, or —SiH₂(R¹³). Particularly in Embodiment 2, each Z is R¹³, —B-(A)₂, —B(A)(R¹³), —NH-(A), —N-(A)₂, —N(A)(R¹³), —SiH(A)₂, —SiH₂(A), —Si(A)₃, —Si(A)₂(R¹³), —Si(A)(R¹³)₂, or —SiH(A)(R¹³). Particularly in Embodiment 2, each Z is R¹³, —B-(A)₂, —B—(R¹³)₂, —NH-(A), —N-(A)₂, —NH—(R¹³), —N—(R¹³)₂, —Si—(R¹³)₃, —SiH(R¹³)₂, —Si(A)(R¹³)₂, or —SiH(A)(R¹³). Embodiment 3 encompasses photoredox catalysts of Embodiment 1 wherein each Z is R¹³, —B-(A)₂, —B—(R¹³)₂, —B(A)(R¹³), —NH-(A), —N-(A)₂, —NH—(R¹³). —N—(R¹³)₂, or —N(A)(R¹³). Particularly in Embodiment 3. each Z is R¹³, —B-(A)₂, —B—(R¹³)₂, —NH-(A), —N-(A)₂, —NH—(R¹³), or —N—(R¹³)₂. Embodiment 4 encompasses photoredox catalysts of Embodiment 1 wherein each Z is —Si—(R¹³)₃, —SiH(R¹³)₂, —SiH₂(R¹³), —SiH(A)₂, —SiH₂(A), —Si(A)₃, —Si(A)₂(R¹³), —Si(A)(R¹³)₂, —SiH(A)(R¹³), —PH₂, —P-(A)₂, —P—(R¹³)₂, —P(R¹³)(A), or —P(O)—(OR¹³ )₂. Particularly in Embodiment 4, each Z is —Si—(R¹³)₃, —SiH(R¹³)₂, —SiH₂(R¹³), —PH₂, —P—(R¹³)₂, or —P(O)—(OR¹³)₂. Particularly in Embodiment 4, each Z is —SiH(A)₂, —SiH₂(A), —Si(A)₃, —Si(A)₂(R¹³), —Si(A)(R¹³)₂, —SiH(A)(R¹³), —P-(A)₂, —P(R¹³)(A), or —P(O)—(OR¹³)₂. In embodiment 5, the disclosure provides photoredox catalysts of Embodiment 1 wherein each Z is —Si—(R¹³)₃, —SiH(R¹³)₂, —SiH₂(R¹³), —SiH(A)₂, —SiH₂(A), —Si(A)₃, —Si(A)₂(R¹³), —Si(A)(R¹³)₂, or —SiH(A)(R¹³). In embodiment 6, the disclosure provides photoredox catalysts of Embodiment 1 wherein each Z is —PH₂, —P-(A)₂, —P—(R¹³)₂, —P(R¹³)(A), or —P(O)—(OR¹³)₂. Embodiment 7 encompasses photoredox catalysts of Embodiment 1 wherein each Z is R¹³, —B-(A)2, or —B—(R¹³)₂. Particularly in Embodiment 7, each Z is R¹³ or —B-(A)₂.

In Embodiment 8 of the disclosure, the photoredox catalyst useful in the methods of the disclosure is wherein Z is R¹³, and such compounds are represented by formula:

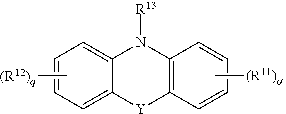

Particular compounds of Embodiment 8 include those of Embodiment 9, i.e., the photoredox catalyst where Y is O, S, NR¹⁴, or C(R¹⁴)₂. In embodiment 10, the disclosure provides photoredox catalysts of Embodiment 8 or 9 wherein Y is O, S, or NR¹⁴. In embodiment 11, the disclosure provides photoredox catalysts of Embodiment 8 or 9 wherein Y is O or S. In embodiment 12, the disclosure provides photoredox catalysts of Embodiment 8 or 9 wherein Y is S. In embodiment 13, the disclosure provides photoredox catalysts of Embodiment 8 or 9 wherein Y is C(R¹⁴)₂. Embodiment 14 encompasses photoredox catalysts of Embodiment 8 wherein Y is absent.

Embodiment 15 encompasses photoredox catalysts of any one of Embodiments 8-14 wherein o and q are independently 0.

In embodiment 16, the disclosure provides photoredox catalysts of any one of Embodiments 8-14 wherein at least one of o and q is 1. Embodiment 17 encompasses photoredox catalysts of Embodiment 16 wherein R¹¹ and R¹² are independently selected from the group consisting of: hydrogen, halogen, cyano, hydroxy, amino, mono or di(C1-C₂₀)alkylamino, C₁-C₆ alkyl, and C₁-C₆ alkoxy. Particularly in Embodiment 17, R¹¹ and R¹² are independently selected from the group consisting of: hydrogen, halogen, hydroxy, amino, mono or di(C₁-C₂₀)alkylamino, C₁-C₆ alkyl, and C₁-C₆ alkoxy.

Particular embodiments based on Embodiments 8-17 include those of Embodiment 18, i.e., photoredox catalysts wherein R¹³ is C₁-C₂₀ alkyl, —C(O)C₁-C₂₀ alkyl, C₃-C₇ cycloalkyl, aryl, aryl(C₁-C₆ alkyl), heteroaryl, or heteroaryl(C₁-C₆ alkyl), wherein each alkyl, cycloalkyl, aryl, and heteroaryl group is optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy. Particularly in Embodiment 18, R¹³ is C₁-C₂₀ alkyl, C₃-C₇ cycloalkyl, aryl, aryl(C₁-C₆ alkyl), heteroaryl, or heteroaryl(C₁-C₆ alkyl), wherein each alkyl, cycloalkyl, aryl, and heteroaryl group is optionally substituted with one or more groups independently selected from C₁-C₆ alkyl, C₁-C₆ alkoxy, halogen, hydroxy, amino, mono- or di- (C₁-C₆) alkylamino, halo(C₁-C₆)alkyl, and halo(C₁-C₆)alkoxy.

Particular embodiments based on Embodiments 8-17 include those of Embodiment 19, i.e., photoredox catalysts wherein R¹³ is C₁-C₂₀ alkyl, aryl, aryl(C₁-C₆ alkyl), heteroaryl, or heteroaryl(C₁-C₆ alkyl), wherein each alkyl, aryl, and heteroaryl group is optionally substituted with one or more groups independently selected from C₁-C₆ alkyl, C₁-C₆ alkoxy, halogen, hydroxy, amino, mono- or dl-(C₁-C₆) alkylamino, halo(C₁-C₆)alkyl, and halo(C₁-C₆)alkoxy.

Particular embodiments based on Embodiments 8-17 include those of Embodiment 20, i.e., photoredox catalysts wherein R¹³ is C₁-C₂₀ alkyl, aryl, or aryl(C₁-C₆ alkyl), wherein each alkyl, aryl, and heteroaryl group is optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy.

Other particular embodiments based on Embodiments 8-17 include those of Embodiment 21, i.e., photoredox catalysts wherein R¹³ is C₁-C₂₀ alkyl or aryl, each optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C1-C₆)alkoxy.

Some other particular embodiments based on Embodiments 8-17 include those of Embodiment 22, i.e., photoredox catalysts wherein R¹³ is C₁-C₆ alkyl or aryl_{;} each optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy.

In embodiment 23, the disclosure provides photoredox catalysts of any one of Embodiments 8-17 wherein R¹³ is C₁-C₄ alkyl or phenyl, each optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy. Embodiment 24 provides photoredox catalysts of Embodiment 23, wherein R¹³ is methyl, phenyl, or 2-, 3-, or 4-(trifluoromethyl)phenyl.

Another embodiment of the disclosure, i.e., Embodiment 25, encompasses photoredox catalysts of Embodiment 8 wherein
Y is O or S;
o and q are independently an integer of 0, 1 or 2;
R¹¹ and R¹² are independently selected from the group consisting of: hydrogen, halogen, cyano, hydroxy, amino, mono or di(C₁-C₂₀)alkylamino, C₁-C₆ alkyl, C₁-C₆ alkoxy, C₃-C₇ cycloalkyl, aryl, or heteroaryl, wherein each alkyl, cycloalkyl, aryl, and heteroaryl group is optionally substituted with from 1-4 groups that are independently C₁-C₆ alkyl, C₁-C₆ alkoxy, halogen, hydroxy, amino, mono- or di-(C₁-C₆) alkylamino, halo(C₁-C₆)alkyl, or halo(C₁-C₆)alkoxy; and
R¹³ is C₁-C₆ alkyl or aryl, each optionally substituted with from 1-4 groups that are independently C₁-C₆ alkyl, C₁-C₆ alkoxy, halogen, hydroxy, amino, mono- or di-(C₁-C₆) alkylamino, halo(C₁-C₆)alkyl, or halo(C₁-C₆)alkoxy.

In embodiment 26, the photoredox catalysts of Embodiments 25 wherein Y is S.

Another embodiment of the disclosure, i.e., Embodiment 27, provides photoredox catalyst that is:

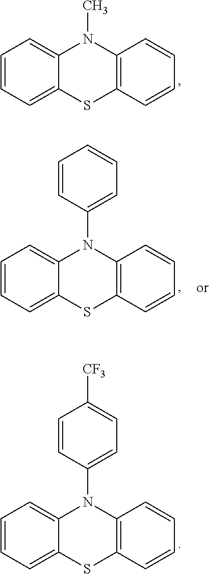

In Embodiment 28 of the disclosure, the photoredox catalyst useful in the methods of the disclosure is wherein Z is —B-(A)₂, and such compounds are represented by formula:

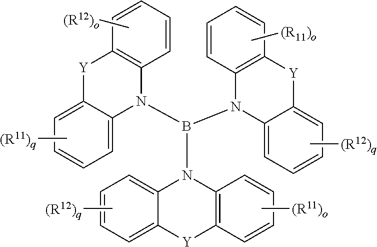

Particular compounds of Embodiment 28 include those of Embodiment 29, i.e., the photoredox catalyst where Y is O, S, NR¹⁴, or C(R¹⁴)₂. In embodiment 30, the disclosure provides photoredox catalysts of Embodiment 28 or 29 wherein Y is O, S, or NR¹⁴. In embodiment 31, the disclosure provides photoredox catalysts of Embodiment 28 or 29 wherein Y is O or S. In embodiment 32, the disclosure provides photoredox catalysts of Embodiment 28 or 29 wherein Y is S. In embodiment 33, the disclosure provides photoredox catalysts of Embodiment 28 or 29 wherein Y is C(R¹⁴)₂. Embodiment 34 encompasses photoredox catalysts of Embodiment 28 wherein Y is absent.

Embodiment 35 encompasses photoredox catalysts of any one of Embodiments 28-34 wherein o and q are independently 0.

In embodiment 36, the disclosure provides photoredox catalysts of any one of Embodiments 28-34 wherein at least one of o and q is 1. Embodiment 37 encompasses photoredox catalysts of Embodiment 26 wherein R¹¹ and R¹² are independently selected from the group consisting of: hydrogen, halogen, cyano, hydroxy, amino, mono or di(C₁-C₂₀)alkylamino, C₁-C₆ alkyl, and C₁-C₆ alkoxy. Particularly in Embodiment 37, R¹¹ and R¹² are independently selected from the group consisting of: hydrogen, halogen, hydroxy, amino, mono or di(C₁-C₂₀)alkylamino, C₁-C₆ alkyl, and C₁-C₆ alkoxy.

Another embodiment of the disclosure, i.e., Embodiment 38, encompasses photoredox catalysts of Embodiment 28 wherein Y is O or S: o and q are independently an integer of 0, 1 or 2; and R¹¹ and R¹² are independently selected from the group consisting of: hydrogen, halogen, cyano, hydroxy, amino, mono or di(C₁-C₂₀)alkylarnino, Cₗ-C₆ alkyl, C₁-C₆ alkoxy, C₃-C₇ cycloalkyl, aryl, or heteroaryl, wherein each alkyl, cycloalkyl, aryl, and heteroaryl group is optionally substituted with from 1-4 groups that are independently C₁-C₆ alkyl, C₁-C₆ alkoxy, halogen, hydroxy, amino, mono- or di-(C₁-C₆) alkylamino, halo(C₁-C₆)alkyl, or halo(C₁-C₆)alkoxy. In embodiment 39, the photoredox catalysts of Embodiments 38 wherein Y is S.

Another embodiment of the disclosure, i.e., Embodiment 40, provides photoredox catalyst that is:

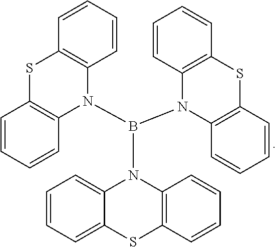 [SMILES: c1ccc2c(c1)Sc1ccccc1N2B(N1c2ccccc2Sc2ccccc21)N1c2ccccc2Sc2ccccc21]

Particular compounds of Embodiment 41 include those of any one of Embodiments 1-7, i.e., the photoredox catalyst where Y is O, S, NR¹⁴, or C(R¹⁴)₂. In embodiment 42, the disclosure provides photoredox catalysts of any one of Embodiments 1-7 wherein Y is O, S, or NR¹⁴. In embodiment 43, the disclosure provides photoredox catalysts of any one of Embodiments 1-7 wherein Y is O or S. In embodiment 44, the disclosure provides photoredox catalysts of any one of Embodiments 1-7 wherein Y is S. In embodiment 45, the disclosure provides photoredox catalysts of any one of Embodiments 1-7 wherein Y is C(R¹⁴)₂. Embodiment 46 encompasses photoredox catalysts of any one of Embodiments 1-7 wherein Y is absent.

Embodiment 46 encompasses photoredox catalysts of any one of Embodiments 1-7 wherein o and q are independently 0.

In embodiment 47, the disclosure provides photoredox catalysts of any one of Embodiments 1-7 wherein at least one of o and q is 1. Embodiment 48 encompasses photoredox catalysts of Embodiment 47 wherein R¹¹ and R¹² are independently selected from the group consisting of: hydrogen, halogen, cyano, hydroxy, amino, mono or di(C₁-C₂₀)alkylamino, C₁-C₆ alkyl, and C₁-C₆ alkoxy. Particularly in Embodiment 48, R¹¹ and R¹² are independently selected from the group consisting of: hydrogen, halogen, hydroxy, amino, mono or di(C₁-C₂₀)alkylamino, C₁-C₆ alkyl, and C₁-C₆ alkoxy.

Particular embodiments based on Embodiments 1-7 and 41-48 include those of Embodiment 49, i,e., photoredox catalysts wherein R¹³, if present, is C₁-C₂₀ alkyl, aryl, aryl(C₁-C₆ alkyl), heteroaryl, or heteroaryl(C₁-C₆ alkyl), wherein each alkyl, aryl, and heteroaryl group is optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy, Other particular embodiments based on Embodiments 1-7 and 41-48 include those of Embodiment 50, i.e., photoredox catalysts wherein R¹³ is C₁-C₂₀ alkyl or aryl, each optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(Cᵣ-C₆)alkoxy. Some other particular embodiments based on Embodiments 1-7 and 41-48 include those of Embodiment 51, i.e., photoredox catalysts wherein R¹³ is C₁-C₆ alkyl or aryl, each optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy. Embodiment 52 provides photoredox catalysts of Embodiment 51, wherein R¹³ is methyl, phenyl, or 2-, 3-, or 4-(trifluoromethyl)phenyl.

As is understood by one of skill in the art, any the photoredox catalyst described above (i.e., the photoredox catalyst of formula II or III, or the photoredox catalyst according to any one of Embodiments 1-52) may be used in methods of the disclosure.

The methods described herein can be operated at relatively low photoredox catalyst levels. Thus, the methods described herein can be performed with significantly lower costs while maintaining good conversion rates and molecular weight control over the polymerization. For example, in certain embodiments, the photoredox catalyst is present at about 0.00001 mol % to about 20 mol % relative to the amount of monomer used. In one embodiment, the methods of the disclosure operate at about 0.005 mol % to about 20 mol % of the photoredox catalyst relative to the amount of monomer used. In certain such embodiments, the photoredox catalyst is present at about 0.005 mol % to about 15 mol %, or 0.005 mol % to about 10 mol %, or 0.005 mol % to about 7.5 mol %, or 0.005 mol % to about 5 mol %, or 0.01 mol % to about 20 mol %, or 001 mol % to about 15 mol %, or 0.01 mol % to about 10 mol %, or 0.01 mol % to about 7.5 mol %, or 0.01 mol % to about 5 mol %, or 0.01 mol % to about 4 mol %, or 0.01 mol % to about 3 mol %, or 0.01 mol % to about 2 mol %, or 0.01 mol % to about 1 mol %, or 0.01 mol % to about 0.9 mork, or 0.01 mork to about 0.8 mol %, or 0.01 mol % to about 0.7 mork, or 0.01 mol % to about 0.6 mol %, or 0.01 mol % to about 0.5 mol %, or 0.01 mol % to about 0.4 mol %, or 0.01 mol % to about 0.3 mark, or 0.01 mol % to about 0.2 mol %, or 0.01 mol % to about 0.1 mol %, or 0.005 mark to about 0.1 mol %, or 0.01 mol % to about 0.07 mol %, or 0.03 mol % to about 0.07 mol %, or 0.04 mol % to about 0.06 mol % of the photoredox catalyst relative to the amount of monomer used. In some embodiments, the photoredox catalyst is present at about 0.01 mol % to about 0.1 mol %. In some embodiments, the photoredox catalyst is present at about 0.05 mol % to about 0.5 mol %. In other embodiments, the photoredox catalyst is present at about 0.05 mol %. In some other embodiments, the photoredox catalyst is present at about 0.1 mol %. In yet other embodiments, the photoredox catalyst is present at about 0.01 mol %. Of course, the person of ordinary skill in the art will understand that in certain embodiments and applications, the amounts of photoredox catalyst used may differ from those particularly described here.

The methods of the disclosure may be carried out in a solvent system to obtain a reaction mixture; and polymerizing the monomers by irradiating the reaction mixture with a light source. As the person of ordinary skill in the art will appreciate, the methods of the disclosure may be carried out in any suitable solvent, depending on the desired need. Embodiments of the invention can be adapted for use with a variety of solvents known in the art, for example dimethyl formamide (DMF), toluene, 1,4-dioxane, xylene, anisole, dimethyl sulfoxide (DMSO), N,N-dimethylacetamide (DMA), tetrahydrofuran (THF), water, methanol, acetonitrile, chloroform and the like.

In addition, in some embodiments of the invention, one or more reactants in the polymerization process (e.g. a monomer) functions a solvent.

In some embodiments, the methods may be carried out in solvent system comprising N,N-dirnethylacetarnide (DMA) to afford excellent control of the polymerization. One of skill in the art will recognize that DMA may be used neat or may be mixed with one or more additional solvents. These additional solvents include, but are not limited to, dimethyl formamide (DMF), toluene, 1,4-dioxane, xylene, anisole, dimethyl sulfoxide (DMSO), tetrahydrofuran (THF), water, methanol, acetonitrile, chloroform and the like. When DMA is mixed with one or more of additional solvents, the solvent system comprising DMA comprises more than about 10 vol % of DMA, or more than about 25 vol % of DMA, or more than about 50 vol % of DMA, or more than about 60 vol % of DMA, or more than about 70 vol % of DMA, or more than about 80 vol % of DMA, or more than about 90 vol % of DMA, or more than about 95 vol % of DMA, or more than about 98 vol % of DMA, or more than about 99 vol % of DMA based on the total volume of solvent. In one embodiment of the methods of the disclosure, the solvent system consists essentially of DMA. In one embodiment, DMA used in the methods of the disclosure is not mixed with any other solvent. Thus, in some embodiments of the methods of the disclosure, the solvent system consists of DMA.

As the person of ordinary skill in the art will appreciate, the methods of the disclosure may be carried out in any suitable concentration of the monomer in the reaction mixture. For example, the reaction mixture may be at a concentration of at least about 1.0 M, of the monomer in the reaction mixture. One of skill in the art will appreciate that the upper limit will depend on the particular monomer used, but will be no more than about 10 M, or 9.0 M, or 8.0 M, or 7.0 M, or 6.0 M, or 5.0 M concentration of the monomer in the reaction mixture. In one embodiment, the reaction mixture is at a concentration of the monomer in the reaction mixture is at least about 1.5 M. In another embodiment, the reaction mixture is at a concentration of the monomer in the reaction mixture is at least about 2.0 M. In another embodiment, the reaction mixture is at a concentration of the monomer in the reaction mixture is at least about 2.1 M, or at least about 2.2 M, or at least about 2.3 M, or at least about 2.4 M, or at least about 2.5 M, or at least about 2.6 M, or at least about 2.7 M, or at least about 2,8 M, or at least about 2.9 M. In another embodiment, the reaction mixture is at a concentration of the monomer in the reaction mixture is at least about 3.0 M. The concentrations particularly suitable for use with acrylate monomers are those that are at least about 2.7 M, or at least about 3.0 M, or at least about 3.2 M, or even at least about 3.5 M. The concentrations particularly suitable for use with methacrylate monomers are those that are at least about 1.0 M, or at least about 1.3 M, or at least about 1.5 M, or at least about 1.7 M, or at least about 2.0 M, or even at least about 2.4 M. The concentrations particularly suitable for use with (meth)acrylamide or (meth)acrylonitrile monomers are those that are at least about 1.0 M, or at least about 1-5 M, or at least about 2.0 M, or at least about 2.5 M or even at least about 3.0 M.

An initiator compound of the disclosure reacts with a monomer in a radical polymerization process to form an intermediate compound capable of linking successively with additional monomer to form a polymer chain(s). Without being bound to a particular theory, it is believed that the number of growing polymer chains can be determined by the initiator. For example, the faster the initiation—the fewer terminations and transfersthe more consistent the number of propagating chains leading to narrow molecular weight distributions. Generally, organic halides may be used as initiators in methods of the disclosure. For example, alkyl halides and pseudo halides may be used. Suitable alkyl halides include alkyl bromides and alkyl chlorides. Initiators other than alkyl halide or pseudo halide that can be used in embodiments of the disclosure include, but are not limited to, allyl halides, xanthates, thioesters, thionoesters, dithioesters, trithiocarbonates, and nitroxides. In some embodiments of the disclosure, the shape or structure of an initiator can be selected to influence the architecture of a polymer. For example, initiators with multiple alkyl halide groups on a single core can lead to a star-like polymer shape. Additionally, suitable initiator may be chosen based on the specific end-functionality of the polymer desired. For example, the initiator suitable for the methods of the disclosure may contain a reactive functional group such as, but not limited to, carboxy, phthalirnido, cyano, N-hydroxysuccinimide ester, pentafluorophenyl ester, etc. The initiator suitable for the methods of the disclosure may be optionally conjugated to a substrate, such as a silicon substrate. Examples of initiators suitable for use in the methods of the disclosure include, but are not limited to:

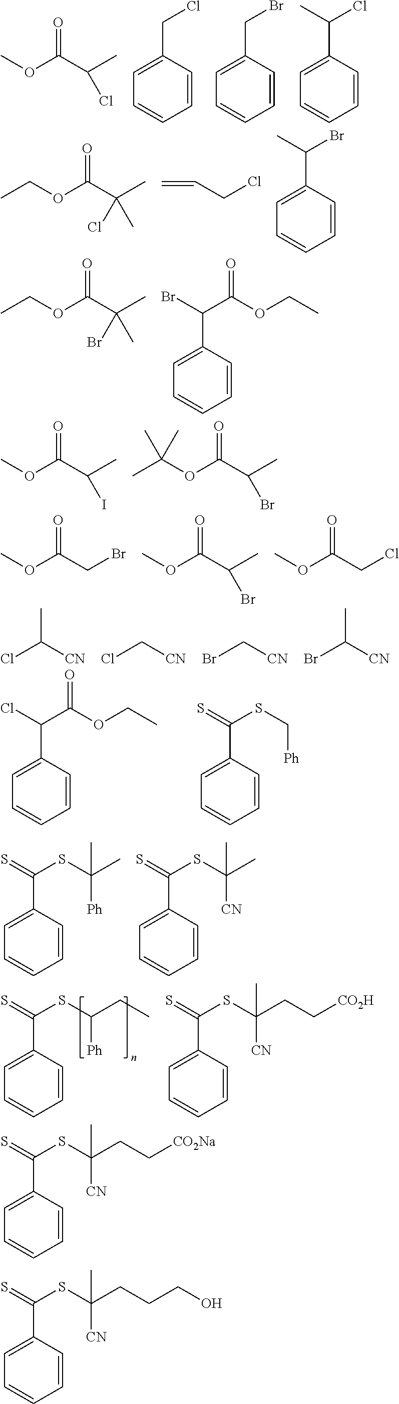

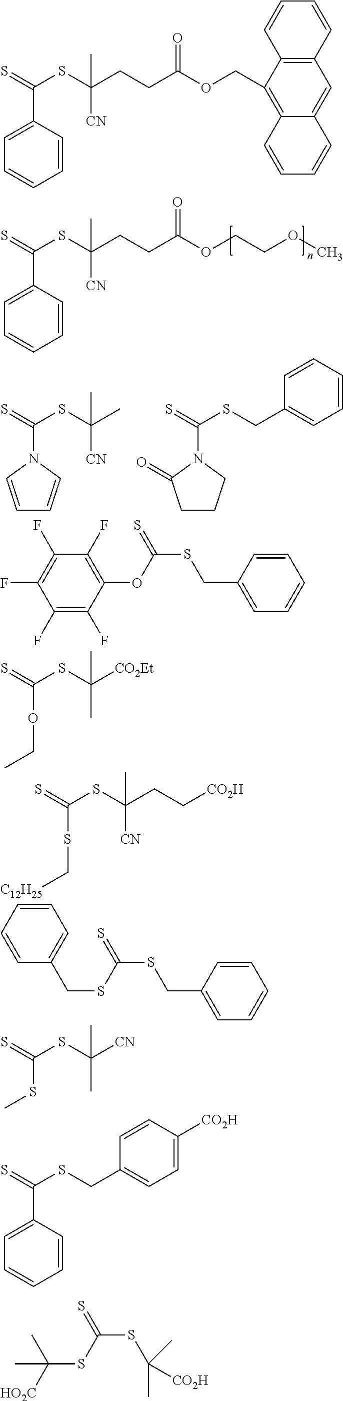

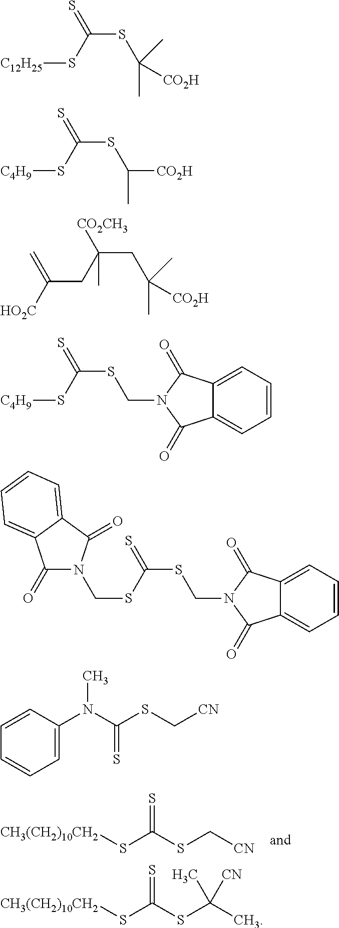

In one embodiment, the initiator suitable for use in the methods of the disclosure is ethyl 2-bromopropanoate, benzyl 2-bromopropanoate, ethyl α-bromoisobutyrate, or benzyl α-bromoisobutyrate. In another embodiment, the initiator is ethyl 2-bromopropanoate or benzyl 2-bromopropanoate. In yet another embodiment, the initiator is ethyl 2-brornopropanoate. In yet another embodiment, the initiator is benzyl 2-brornopropanoate.

As is known in the art, monomers encompass a class of compounds, mostly organic, that can react with other molecules of the same or other compound to form very large molecules, or polymers. Monomers that are typically used in polymerization reactions include molecules with substituents that can stabilize the propagating radicals. The methods described herein may be performed using, for example, (meth)acrylate, (meth)acrylamide, (meth)acrylonitrile, styrene, vinyl acetate, vinylpyridine, and vinyl chloride monomers available to one skill in the art, and may be varied depending on the desired product. Monomers that undergo radical polymerization in the disclosed methods include but are not limited to typical alkene monomers that undergo traditional radical polymerization. Examples include, but not limited to, alkyl methacrylates (e.g., methyl methacrylate), acrylates (including various alkyl acrylates), styrenes, methacrylic acid, acrylic acid, benzyl methacrylate, benzyl acrylate, acrylamide, alkylacrylamide, dialkyl acrylamide (e.g., N,N-dimethylacrylamide), methacrylarnide, alkyl methacrylamide, dialkyl methacrylarnide, acrylonitrile, methacrylonitrile, vinyl acetate, vinylpyridine, vinyl chloride, acrylamides, etc. The monomers may be further functionalized with one or more of reactive functional groups, which include, but are not limited to, carboxylic acids, amines, amides, alcohols, ketones, aldehydes, alkynes, fluorides, chlorides, bromides, iodides, ethers, esters, hydroxylamines, irnines, azides, nitriles, isocyanates, isocyanides, nitrites, nitrosos, thiols, thioethers, sulfoxides, sulfonic acids, thiocyanates, isothiocyanates, thiones, thials, phosphines, phosphonic acids, phosphates, boronic acid, boronic esters, borinic acids, hetroarornatics, and heterocycles.

In one embodiment of the disclosure, the monomer is a methacrylate monomer. In another embodiment, the methacrylate may be selected from methacrylic acid, methyl methacrylate, ethyl methacrylate, and butyl methacrylate. In another embodiment, the methacrylate comprises a mixture, e,g., one of the monomers is methacrylate and one of the monomers is acrylate. In another embodiment of the disclosure, the monomer is an acrylate monomer. In another embodiment, the acrylate may be selected from acrylic acid, methyl acrylate, ethyl acrylate, and butyl acrylate.

The methods of the disclosure allow precise control of polymer growth so as to form polymers having selected lengths and/or selected molecular weights (e.g. within selected MW ranges) and/or selected molecular weight distributions and/or selected architectures. In certain embodiments of the disclosure, polymer chains have a structure selected from a group consisting of block copolymers; random copolymers; gradient copolymers; periodic polymers; alternating polymers; statistical polymers; linear polymers; branched polymers; star polymers; brush polymers; comb polymers; graft polymers, and cyclic polymers. In one embodiment, the polymers are formed from at least two or more monomers. In another embodiment, the acrylic polymer prepared by the methods of the disclosure is a block, random, gradient, alternating, brush, or star copolymer comprised of at least two different monomers. In another embodiment, the acrylic polymer prepared by the methods of the disclosure is a block, random, or gradient copolymer comprised of at least two different monomers. In some other embodiments, the acrylic polymer prepared by the methods of the disclosure is comprised of the same monomer.

As the rate of polymer formation is directly proportional to the amount of light exposure in embodiments of the disclosed methods, optionally, for example, polymer chain lengths in a reaction mixture are regulated by controlling an amount of time that the reaction mixture is exposed to light; and/or by controlling the intensity of light that reaches the reaction mixture. Embodiments of the invention can comprise exposing a reaction mixture to light multiple times in order to precisely tailor one or more characteristics of a polymer composition. For example, in some methods of the disclosure, a reaction mixture is first exposed to light for a period of time so that the radical polymerization process is activated; followed by period of time during which this reaction mixture is protected from light exposure so that the radical polymerization process is deactivated; and then re-exposing the reaction mixture to light for a period of time so that the radical polymerization process is re-activated, etc. One of skill in the art will appreciate that a light source may be one of the wide varieties of optical sources known in the art.

The methods disclosed herein can be used to form polymeric materials that have a number of desirable qualities including for example, a relatively low polydispersity. Optionally in embodiments of the invention, the polymer chains exhibit a polydispersity index such that M_{w}/Mₙ is between about 1.0 and about 2.5. In some embodiments, the polydispersity index is between about 1.0 and about 2.0, or between about 1.0 and about 1.9, or between about 1.1 and about 1.9, or between about 1.0 and about 1.8, or between about 1.1 and about 1.8, or between about 1.0 and about 1.7, or between about 1.1 and about 1.7, or between about 1.2 and about 1.7, or between about 1.2 and about 1.6, or about 1.0, or about 1.1, or about 1.2, or about 1.3, or about 1.4, or about 1.5, or about 1.6, or about 1.7, or about 1.8, or about 1.9, or even about 2.0. In certain embodiments, the polymer exhibits a polydispersity of M_{w}/Mₙ between about 1.0 and about 1.5. In some other embodiments, the polymer exhibits a polydispersity of between about 1.2 and about 1.4. In certain embodiments of the disclosure, the polydispersity index of the polymer chains may be greater than 2.0, and can be, for example, greater than about 5, or about 10, or about 25, or about 50, or about 100, or about 150, or about 200.

In addition to removing the light source, one of skill in the art will recognize that the polymerization may be discontinuing by any method known in the art. For example, the polymerization may be discontinued by addition of a quenching reagent known in the art. In this embodiment, the light source may or may not be still present. Finally, one of skill in the art will recognize that the polymerization might be discontinued upon exhausting the monomers available for the reaction.

As noted above, methods of the disclosure may be used to prepare a polymer of the formula I. In particular embodiments, the compounds of formula I are those wherein X is —Br. In other embodiments, each R¹ and R¹′ is independently OH or C₁-C₆ alkoxy. In one embodiment, each R′ and R¹′ is C₁-C₆ alkoxy. In an exemplary embodiment, each R¹ and R¹′ is selected from methoxy, ethoxy, and butoxy. In another embodiment, one of R¹ and R¹′ is C₁-C₆ alkoxy, and the other is —OH. In certain embodiments, each R⁵ and R⁵′ is independently is H. In some other embodiments, each R⁵ and R⁵′ is independently is methyl. In some other embodiments, one of R⁵ and R⁵′ is H, and the other is methyl. One of skill in the art will recognize that R², R³, and R⁴ will depend on the particular initiator used.

The methods described herein can be performed under inert atmosphere using standard degassing procedures, as known to one skilled in the art. These methods can also be performed under an oxygen-containing atmosphere, e.g., in a sealed reactor containing atmospheric levels of oxygen with no special precautions used to remove oxygen. For systems containing atmospheric levels of oxygen, it is advantageous to use 0.5 mol % photoredox catalyst.

### Definitions

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used in the specification and the appended claims, the singular forms “a,” “an” and “the” include plural referents unless the context clearly dictates otherwise.

Ranges can be expressed herein as from “about” one particular value, and/or to “about” another particular value. When such a range is expressed, another aspect includes from the one particular value and/or to the other particular vaiue. Similarly, when vaiues are expressed as approximations, by use of the antecedent “about,” it will be understood that the particular value forms another aspect. It will be further understood that the endpoints of each of the ranges are significant both in relation to the other endpoint, and independently of the other endpoint.

As used herein the term “combining” includes adding one or more items to a reaction mixture.

As used herein the term “dispersity,” “polydispersity,” “polydispersity index”, “PDI,” and “M_{w}/Mₙ” are used interchangeably and refer to measure of the polymer uniformity with respect to distribution of molecular mass. The dispersity may be caiculated by dividing weight average molecular weight (M_{w}) by the number average molecular weight (Mₙ) (i.e., M_{w}/Mₙ). In certain embodiments, the dispersity may be calculated according to degree of polymerization, where the dispersity equals X_{w}/Xₙ, where X_{w} is the weight-average degree of polymerization and Xₙ is the number-average degree of polymerization.

All percentages, ratios and proportions herein are by weight, unless otherwise specified. A weight percent (weight %, also as wt %) of a component, unless specifically stated to the contrary, is based on the total weight of the composition in which the component is included (e.g., on the total amount of the reaction mixture).

The term “alkoxy” as used herein, means an alkyl group, as defined herein, appended to the parent molecular moiety through an oxygen atom. Representative examples of alkoxy include, but are not limited to, methoxy, ethoxy, propoxy, 2-propoxy, butoxy, tert-butoxy, pentyloxy, and hexyloxy.

The term “alkyl” as used herein, means a straight or branched chain hydrocarbon containing from 1 to 20 carbon atoms unless otherwise specified. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dmethylpentyl, 2,3-dimethylpentyl, n-heptyl, n-octyl, n-nonyl, and n-decyl. The term “alkylene” refers to a divalent alkyl group, where alkyl is as defined herein.

The term “aryl,” as used herein, means a phenyl (i.e., monocyclic aryl), or a bicyclic ring system containing at least one phenyl ring or an aromatic bicyclic ring containing only carbon atoms in the aromatic bicyclic ring system, or a polycyclic ring system containing at least one phenyl ring. The bicyclic aryl can be azulenyl, naphthyl, or a phenyl fused to a cycloalkyl, a cycloalkenyl, or a heterocyclyl. The bicyclic or polycyclic aryl is attached to the parent molecular moiety through any carbon atom contained within the phenyl portion of the bicyclic or polycyclic system, or any carbon atom with the napthyl, azulenyl, anthracene, or pyrene ring.

The term “aryloxy” as used herein, means an aryl group, as defined herein, appended to the parent molecular moiety through an oxygen atom. Representative examples of aryloxy include, but are not limited to, phenyloxy and naphthoxy.

The term “cycloalkyl” refers to a monocyclic or a bicyclic cycloalkyl ring system. Monocyclic ring systems are cyclic hydrocarbon groups containing from 3 to 8 carbon atoms, where such groups can be saturated or unsaturated, hut riot aromatic. Examples of cycloalkyl include cyclopropyl, cyclobutyl, cyclopentyl, cyclohexyl, cycloheptyl and cyclooctyl. More preferred are C₃-C,₃ cycloalkyl groups. In certain embodiments, cycloalkyl groups are fully saturated. Examples of monocyclic cycloalkyls include cyclopropyl, cyclobutyl, cyclopentyl, cyclopentenyl, cyclohexyl, cyclohexenyl, cycloheptyl, and cyclooctyl. Bicyclic cycloalkyl ring systems are bridged monocyclic rings or fused bicyclic rings. Bridged monocyclic rings contain a monocyclic cycloalkyl ring where two non-adjacent carbon atoms of the monocyclic ring are linked by an alkylene bridge of between one and three additional carbon atoms (i.e., a bridging group of the form —(CH₂)_{w}—, where w is 1, 2, or 3). Representative examples of bicyclic ring systems include, but are not limited to, bicyclo[3.1.1]heptane, bicyclo[2.2.1]heptane, bicyclo[2.2.2]octane, bicyclo[3.2.2]nonane, bicyclo[3.3.1]nonane, and bicyclo[4.2.1]nonane. Fused bicyclic cycloalkyl ring systems contain a monocyclic cycloalkyl ring fused to either a phenyl, a monocyclic cycloalkyl, a monocyclic cycloalkenyl, a monocyclic heterocyclyl, or a monocyclic heteroaryl. The bridged or fused bicyclic cycloalkyl is attached to the parent molecular moiety through any carbon atom contained within the monocyclic cycloalkyl ring.

The term “halogen” as used herein, means —Cl, —Br, —I or —F.

The term “haloalkoxy” refers to an alkoxy group substituted with one or more halogen atoms, where each halogen is independently F, Cl, Br or I. “Haloalkoxy” includes perhaloalkoxy groups, such as OCF₃ or OCF₂CF₃.

The term “haloalkyl” refers to an alkyl group substituted with one or more halogen atoms, where each halogen is independently F, Cl, Br or I.

The term “heteroaryl,” as used herein, means a monocyclic heteroaryl or a bicyclic or polycyclic ring system containing at least one heteroaromatic ring. The monocyclic heteroaryl can be a 5 or 6 membered ring. The 5 membered ring consists of two double bonds and one, two, three or four nitrogen atoms and optionally one oxygen or sulfur atom. The 6 membered ring consists of three double bonds and one, two, three or four nitrogen atoms. The 5 or 6 membered heteroaryl is connected to the parent molecular moiety through any carbon atom or any nitrogen atom contained within the heteroaryl. The bicyclic or polycyclic heteroaryl consists of a heteroaryl fused to a phenyl, a cycloalkyl, a cycloalkenyl, a heterocyclyl, or a heteroaryl. Representative examples of heteroaryl include, but are not limited to, furyl, imidazolyl, isoxazolyl, isothiazolyl, oxadiazolyl, oxazolyl, pyridinyl, pyridazinyl, pyrimidinyl, pyrazinyl, pyrazolyl, pyrrolyl, tetrazolyl, thiadiazolyl, thiazolyl, thienyl, triazolyl, triazinyl, benzimidazolyl, benzofuranyl, benzothienyl, benzoxadiazolyl, benzoxathiadiazolyl, benzothiazolyl, cinnolinyl, 5,6-dihydroquinolin-2-yl, 5,6-dihydroisoquinolin-1-yl, furopyridinyl, indazolyl, indolyl, isoquinolinyl, naphthyridinyl, quinolinyl, or purinyl.

### EXAMPLES

The methods of the disclosure is illustrated further by the following examples, which are not to be construed as limiting the disclosure in scope or spirit to the specific procedures and compounds described in them. In all cases, unless otherwise specified, the column chromatography is performed using a silica gel solid phase.

Material and equipment

All polymerizations were carried out under an argon atmosphere. Anhydrous N,N-dimethylacetamide was purchased from Sigma-Aldrich and used as received. Methyl methacrylate was purchased from Sigma-Aldrich and passed through a plug of basic alumina before use. Methylene blue, Eosin Y, ethyl α-bromophenylacetate, 10-methyl phenothiazine, phenothiazine, RuPhos, and chlorobenzene were purchased from Sigma-Aldrich and used as received. RuPhos Precatalyst was purchased from Strem Chemicals Inc,

Nuclear magnetic resonance spectra were recorded on a Varian 400 MHz, a Varian 500 MHz, or a Varian 600 MHz instrument. All ¹H NMR experiments are reported in δ units, parts per million (ppm), and were measured relative to the signals for residual chloroform (7.26 ppm) in the deuterated solvent, unless otherwise stated. All ¹³C NMR spectra are reported in ppm relative to deuterochloroform (77.23 ppm), unless otherwise stated, and all were obtained with ¹H decoupling. Gel permeation chromatography (GPO) was performed on a Waters 2695 separation module with a Waters 2414 refractive index detector in chloroform with 0.25% triethylamine. Number average molecular weights (Mₙ) and weight average molecular weights (M_{w}) were calculated relative to linear polystyrene standards for calculation of M_{w}/Mₙ. The molecular weight (Mₙ) was calculated using ¹H NMR by comparing the integration of the ethyl peak in the initiator to the methyl peak in the polymer side chain unless otherwise noted.

LED strips (380 nm) were bought from elemental led (see www.elementalled.com) and used as shown below (FIG. S1). Reactions were placed next to the 380 nm lights under vigorous stirring while cooling with compressed air. The light intensity was measured to be 0.65 μW/cm².

### Example 1

### Synthesis of 10-bhenviphenothiazine (PTH):

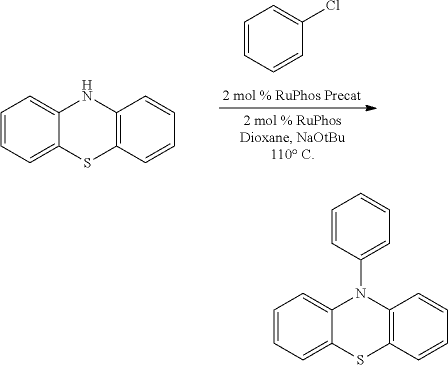 [SMILES: Clc1ccccc1 ; c1ccc2c(c1)Nc1ccccc1S2 ; c1ccc(N2c3ccccc3Sc3ccccc32)cc1]

The following procedure was adopted from Maiti et al, (Chem. Sci. 2010, 2, 57.) To a vial armed with a magnetic stir bar was added NaOtBu (134 mg, 1.4 mmol), phenothiazine (199 mg, 1 mmol), RuPhos Precat (14 mg, 0.02 mmol, 2 mol %), and RuPhos (8 mg, 0.02 mmol, 2 mol %). The vial was evacuated and backfilled 3× with argon before adding dry Dioxane (1 mL). Lastly, anhydrous chlorobenzene (143 μL, 1.4 mmol) was added. The vial was then placed in an oil bath at 110° C. and let react for 5 h. The vial was then cooled to room temperature, diluted with OH₂Cl₂, washed with water, brine, dried with Mg₂SO₄, and run through a silica plug (5% EtOAc/Hexanes). The product was then dried under reduced pressure to yield 267 mg of a white solid (97% yield). ¹H NMR (600 MHz, CDCl₃) δ: 7.60 (t, J =8 Hz, 2H), 7.49 (t, J =8 Hz, 1H), 7,40 (d, J=7 Hz, 2H), 7.02 (d, J=8 Hz, 2H), 6.86-6.79 (m, 4 H), 6.20 (d, J=8 Hz, 2 H) ppm. ^{—}C NMR (151 MHz, CDCl₃) δ: 144.5, 141,2, 131.1, 130.9, 128.4, 127.0, 126.9, 122.7, 120.4, 116.3 ppm.

Chemical Structures of Catalysts Tested:

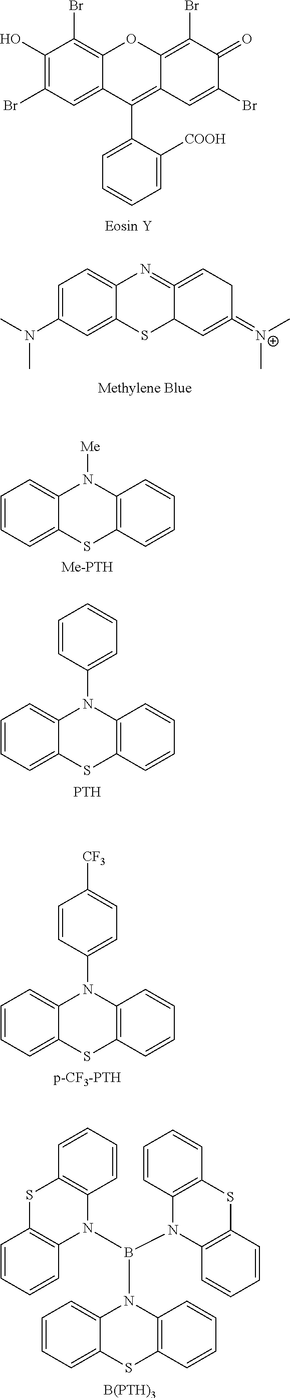

### Example 2

Commercially available 10-methylphenothiazine (Me-PTH) was used for the polymerization of methyl methacrylate under similar conditions to Ir-based system disclosed in U.S. Provisional Application No. 61/976,178, filed April 7, 2014, and which is incorporated herein in its entirety. In short, a vial equipped with a magnetic stir bar and fitted with a teflon screw cap septum was charged with methyl methacrylate (401 μL, 3.75 mmol), photocatalyst (0.1 mol %) and dimethylacetamide (1 mL). The reaction mixture was degassed with three freeze-pump-thaw cycles. The vial was then backfilled with argon and benzyl α-bromophenylacetate (6.6 μL, 0.0375 mmol) was injected via syringe. The reaction was vigorously stirred in front of 380 nm LEDs while cooling with compressed air to maintain ambient temperature. The reaction was allowed to proceed to ca. 50% conversion of MMA as monitored by ¹H NMR. An aliquot was taken and analyzed using GPC to give the molecular weight (Mₙ) and molecular weight distribution (M_{w}/Mₙ) of the polymer.

TABLE 1
Light-mediated polymerization of methyl methacrylate using organic photoredox
catalysts^{[a]}

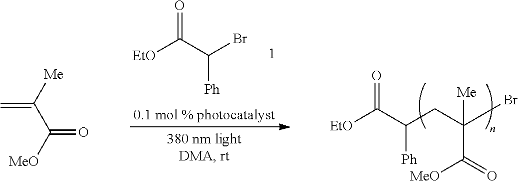

| | | Mₙ (exp) | Mₙ (theo) | |
|---|---|---|---|---|
| Entry | Catalyst | [g/mol] | [g/mol] | M_{w}/Mₙ |
| 1 | Me-PTH | 8,300 | 7,400 | 1.74 |
| 2^{[b]} | PTH | 15,400 | 14,000 | 1.32 |
| 3^{[b]} | PTH | 11,500 | 12,800 | 1.30 |
| 4 | PTH | 6,200 | 7,200 | 1.30 |
| 5 | PTH | 2,400 | 2,600 | 1.18 |
| 6 | PTH | 1,300 | 1,800 | 1.20 |
| 7^{c]} | PTH | — | — | — |
| 8^{[d]} | Eosin Y | — | — | — |
| 9^{[d]} | Methylene Blue | — | — | — |

^{[a]}Mn = number average molecular weight; Mw = weight average molecular weight). Mₙ and M_{w}/Mₙ determined using size exclusion chromatography (SEC) or ¹H NMR;
^{[b]}benzyl methacrylate was used;
^{[c]}reaction run in the dark; and
^{[d]}reaction irradiated with visible light (50 W fluorescent bulbs).

Polymerization was observed with good agreement between theoretical and experimental molecular weight, albeit with poor control over the molecular weight distribution (Table 1, entry 1). Use of a phenothiazine derivative further stabilized the radical cation species leading to more efficient recapping of the alkyl bromide species and gave greater control over the polymerization process. To this end, 10-phenylphenothiazine (PTH, E_{red}(PTH*/PTH*)=−2.4 V vs. SCE) was made in one step from commercially available materials and tested under previously reported reaction conditions. A low polydispersity was obtained while maintaining good agreement between experimental and theoretical Mₙ. In addition, by adjusting the initiator concentration various molecular weights were targeted while maintaining excellent control (Table 1, entries 2-6). These experiments establish that, for the first time, an atom transfer radical polymerization (ATRP) like process could occur with a metal-free catalyst system. When the reaction was run under the optimized conditions but in the absence of light, no polymerization was observed (Table 1, entry 7), demonstrating that process is indeed a photomediated process. Moreover, when other organic-based photoredox catalysts were employed (Eosin Y and Methylene Blue), which are oxidizing in the excited state, no reaction occurred (Table 1, entries 8 and 9).

### Example 3

A vial equipped with a magnetic stir bar and fitted with a rubber septum was charged with methyl methacrylate (2.4 mL, 22.5 mmol), 10-phenylphenothiazine (6.2 mg, 0.1 mol %) and dimethylacetamide (6 mL). The reaction mixture was degassed with three freeze-pump-thaw cycles. The vial was then backfilled with argon and benzyl a-bromophenylacetate (39 μL, 0.225 mmol) was injected via syringe. The reaction was stirred in front of 380 nm LEDs while cooling with compressed air to maintain ambient temperature. The reaction was stirred in front of the light for 2.5 h (14% conv.) and then put into the dark by wrapping it in aluminum foil. A syringe wrapped in aluminum foil was used to transfer the reaction mixture in the dark into a stirring solution of hexanes (50 mL, also wrapped in aluminum foil). The white precipitate was decanted, and re-dissolved in dichloromethane before precipitating again into hexanes to yield 280 mg of a white powder. Mₙ=2,900 g/mol, M_{w}/Mₙ=1.33.

### Example 4

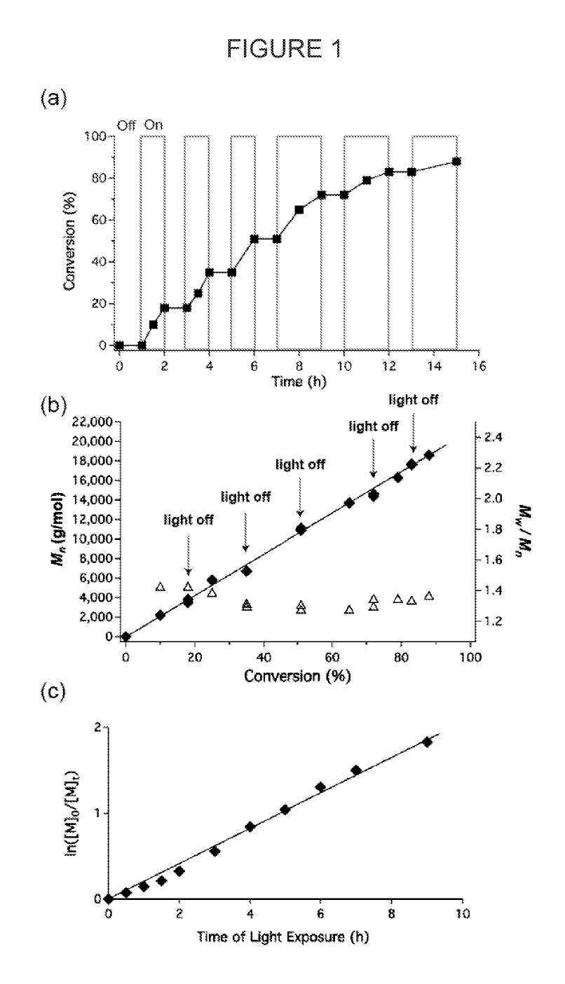

The lack of reaction in the absence of light suggested that this new system could be activated/deactivated by light in a reversible and responsive manner similar to the Ir-based system. 10-phenylphenothiazine (PTH) was combined with benzyl methacrylate (BnMA) under the optimized reaction conditions and initially placed in the dark for 1 hour. Upon observing no conversion during this period (FIG. 1a), the reaction was exposed to light, reaching 18% conversion in 1 hour. Subsequently, the reaction was then placed in the dark with no conversion observed, indicating efficient deactivation. This cycle was repeated several times with no polymerization in the dark and efficient reactivation of chain ends upon irradiation up to high conversions (88%). For the same experiment, the molecular weight vs. conversion was monitored (FIG. 1b), and a linear increase was observed. Further, first order kinetics were observed through the course of the reaction, demonstrating that a constant radical concentration was maintained in the presence of light (FIG. 1c). This data indicates that when light is removed from the system the chain-ends are efficiently oxidized to the stable and dormant alkyl bromides and upon re-exposure to light the chain-ends efficiently reactivated. This establishes that the use of 10-phenylphenothiazine as a catalyst allows excellent regulation of the polymerization process with light.

### Example 5

2-(Dimethylarnino)ethyl methacrylate (DMAEMA) is a monomer utilized ubiquitously in industry and academia for its stimuli-responsive properties. When Ir(ppy)₃ was combined with DMAEMA under the previously reported conditions, very broad polydispersities were observed (Table 2, entry 1). Without being bound to particular theory, it is believed that oxidation potential of Ir(ppy)₃ (E_{1/2}^{ox}=0.77 V vs. SCE) was leading to oxidation of the amine, yielding uncontrolled polymerization. By moving to the less oxidizing 10-phenylphenothiazine (PTH) (E_{1/2}^{ox}=0.68 V vs. SCE), monomer oxidation could be suppressed and controlled polymerization could be obtained. Thus, when PTH was combined with DMAEMA and irradiated under standard conditions, very low polydispersities were observed (Table 2, entries 2-3). This exemplifies that by switching to this organic catalyst, new reactivity can be realized, which gives broader monomer scope than Ir(ppy)₃.

TABLE 2
Light-mediated polymerization of dimethylaminoethyl methacrylate using organic
photoredox catalysts^{[a]}

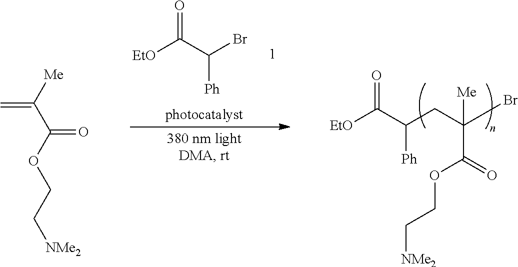

| | | Mₙ (exp) | |
|---|---|---|---|
| Entry | Catalyst | [g/mol] | M_{w}/Mₙ |
| 1^{[b]} | Ir(ppy)₃ | 9,400 | 3.69 |
| 2 | PTH | 8,800 | 1.11 |
| 3 | PTH | 5,100 | 1.26 |

^{[a]}Reaction conditions: DMAEMA (1 equiv.), photocatalyst (0.1 mol %), ethyl 2-bromo-2-phenylacetate (1) (0.01 equiv), DMA (2 M of DMAEMA) at room temperature with irradiation from 380 nm LEDs for 3-7 h (Mₙ = number average molecular weight; M_{w} = weight average molecular weight). Mₙ and M_{w}/Mₙ determined using size exclusion chromatography (SEC) or ¹H NMR; and
^{[b]}used 0.005 mol % Ir(pph)₃

### Example 6

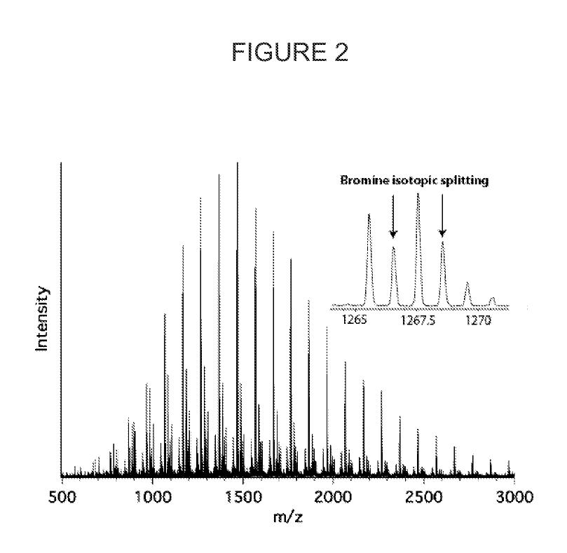

Good chain-end fidelity is an important characteristic of controlled radicals and enables the synthesis of well-defined macromolecules. Thus, to provide evidence of bronco chain ends, a low molecular weight poly(methyl methacrylate) (PMMA) (Mₙ=2,600 g/mol, M_{w}/Mₙ=1.33) was synthesized under the conditions described in Example 1, and analyzed using Electrospray ionization mass spectrometry (ESI-MS) (FIG. 2). The splitting pattern of the major peaks in the spectrum clearly showed the presence of bromine isotopes (FIG. 2, inset), and the masses matched that of theory.

### Example 7

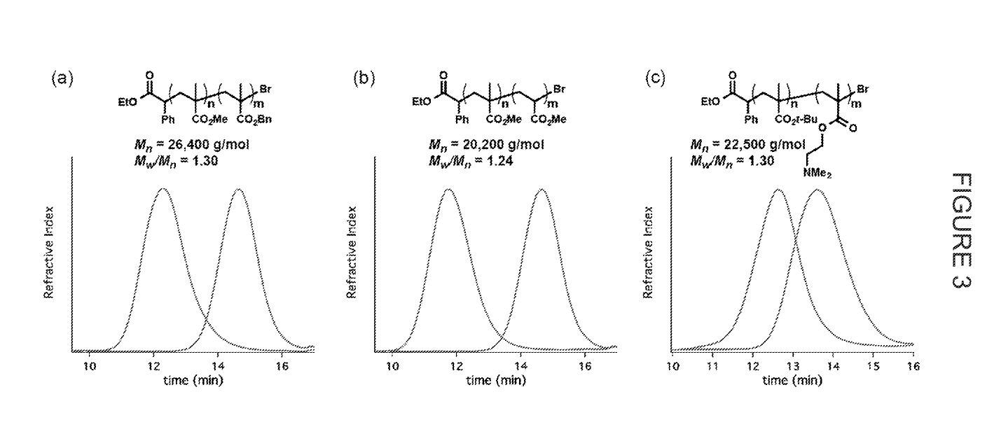

Block copolymerization was performed to show that a system with living characteristics is in place. Specifically, 0.1 mol % 10-phenylphenothiazine (PTH), ethyl 2-bromo-2-phenylacetate (1), and methyl methacrylate (MMA) were combined in DMA and irradiated to produce a low molecular weight poly(methyl methacrylate) (PMMA) homopolymer (Mₙ=3,600 g/mol, M_{w}/Mₙ=1.19). Next, the homopolymer was combined under the optimized conditions with benzyl methacrylate and irradiated for 4 h to synthesize a PMMA-b-PBnMA block copolymer (FIG. 3a). The size exclusion chromatogram (SEC) clearly shows a shift to higher molecular weight species with little tailing in the homopolymer regime,

To further explore the scope and chain-end fidelity of the organocatalyzed system, a PMMA homopolymer was produced and chain extended with methyl acrylate using the previously developed conditions employing Ir(ppy)₃. These two methods were found to be completely orthogonal, producing a monodisperse block copolymer (FIG. 3b) with virtually no tailing in the homopolymer regime of the SEC trace, demonstrating the ability of the disclosed system to be combined with other polymerization methods to make well-defined materials.

To exhibit the ability to synthesize functional materials with this method, PtBuMA homopolymer was prepared and chain extended with DMAEMA to produce a well-defined, stimuli-reponsive block copolymer (Mₙ=22,500 g/mol, M_{w}/Mₙ=1.30) (FIG. 3c).

### Example 8

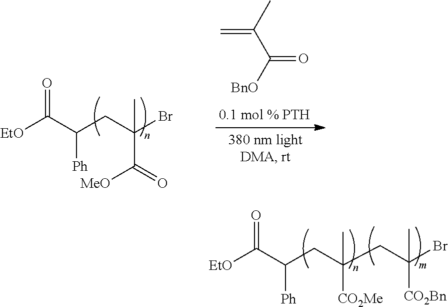

A vial equipped with a magnetic stir bar and fitted with a teflon screw cap septum was charged with benzyl methacrylate (551 μL, 3,77 mmol), PTH (0.9 mg, 0.1 mol %) and dimethylacetamide (400 μL). In another flask, 400 μL of dimethylacetamide was added to the poly(methyl methacrylate) macroinitiator (86 mg, 0.014 mmol). Both reaction mixtures were degassed with three freeze-pump-thaw cycles. Using a syringe, the monomer and catalyst were then transferred to the flask containing macroinitiator. The reaction was stirred in front of 380 nm LEDs while cooling with compressed air to maintain ambient temperature. After 4 h (59% conv.) the reaction was stopped by opening to air and precipitated into methanol (20 mL). The precipitate was filtered and redissolved in CH₂Cl₂ before repricipitating into methanol. The product was analyzed by ¹H NMR and GPC. (yield: 180 mg of a white powder) Mₙ=27,400 g/mol, M_{w}/Mₙ=1.49.

### Example 9

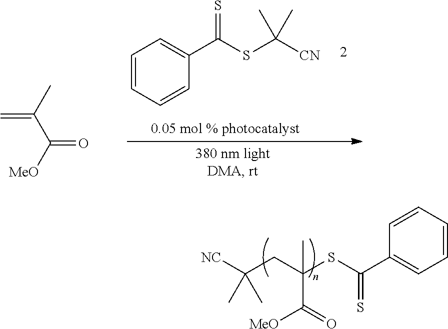

A vial equipped with a magnetic stir bar and fitted with a teflon screw cap septum was charged with methyl methacrylate (401 μL, 3.75 mmol), photocatalyst (0.05 mol %), RAFT agent 2 (4.1 mg, 0.0188 mmol), and dimethylacetamide (1 mL). The reaction mixture was degassed with three freeze-pump-thaw cycles in the dark. The vial was then backfilled with argon and vigorously stirred in front of 380 nm LEDs while cooling with compressed air to maintain ambient temperature. The reaction conversion was monitored by ¹H NMR. An aliquot was taken and analyzed using GPC to give the molecular weight (Mₙ) and molecular weight distribution (M_{w}/Mₙ) of the polymer, with the results shown in Table 3

TABLE 3
Controlled polymerization of MMA using
a commonly employed RAFT agent

| | | | GPC Mₙ | Mₙ (theoretical) | |
|---|---|---|---|---|---|
| Photocatalyst | time | Conversion | (g/mol) | (g/mol) | M_{w}/Mₙ |
| Me-PTH | 11 h | 18% | 6,400 | 3,600 | 1.27 |
| PTH | 11 h | 47% | 12,500 | 9,400 | 1.46 |

### Example 10

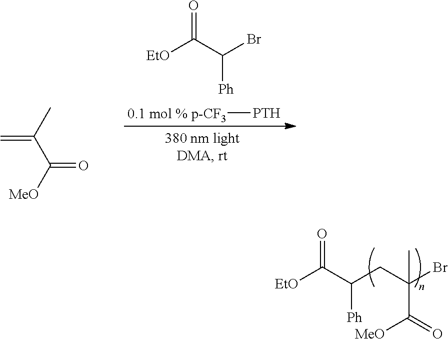

A vial equipped with a magnetic stir bar and fitted with a teflon screw cap septum was charged with methyl methacrylate (401 μL, 3.75 mmol), p-CF₃-PTH (1.3 mg, 0.1 mol %) and dimethylacetamide (1 mL). The reaction mixture was degassed with three freeze-pump-thaw cycles. The vial was then backfilled with argon and benzyl a-bromophenylacetate (6.6 μL, 0.0375 mmol) was injected via syringe. The reaction was vigorously stirred in front of 380 nm LEDs for 4 h while cooling with compressed air to maintain ambient temperature. The conversion of MMA was determined by ¹H NMR to be 35%. An aliquot was taken and analyzed using GPC to give the molecular weight (Mₙ=4,500 g/mol) and molecular weight distribution (M_{w}/Mₙ=1.36) of the polymer.

### Example 11

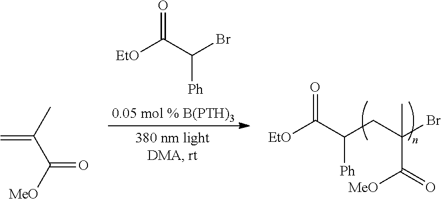

A vial equipped with a magnetic stir bar and fitted with a teflon screw cap septum was charged with methyl methacrylate (401 μL. 3.75 mmol), B(PTH)₃ (1.1 mg, 0.05 mol %) and dimethylacetamide (1 mL). The reaction mixture was degassed with three freeze-pump-thaw cycles. The vial was then backfilled with argon and benzyl α-bromophenylacetate (6.6 μL, 0.0375 mmol) was injected via syringe. The reaction was vigorously stirred in front of 380 nm LEDs for 5 h while cooling with compressed air to maintain ambient temperature. Conversion of MMA was determined by ¹H NMR to be 34%. An aliquot was taken and analyzed using GPO to give the molecular weight (Mₙ=4,500 g/mol) and molecular weight distribution (M_{w}/Mₙ=1.38) of the polymer.

### Example 12

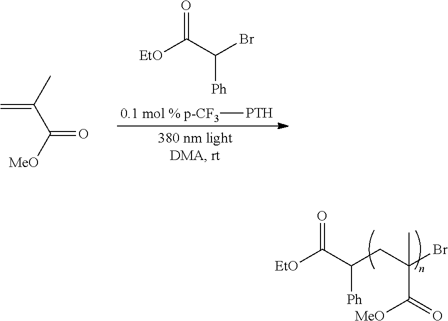

A vial equipped with a magnetic stir bar and fitted with a rubber septum was charged with methyl methacrylate (2.4 mL, 22.5 mmol), p-CF₃-PTH (7.7 mg, 0.1 mol %) and dimethylacetamide (6 mL). The reaction mixture was degassed with three freeze-pump-thaw cycles. The vial was then backfilled with argon and benzyl α-bromophenylacetate (39 μL, 0,225 mmol) was injected via syringe. The reaction was stirred in front of 380 nm LEDs while cooling with compressed air to maintain ambient temperature. The reaction was stirred in front of the light for 2.5 h (17% conv.) and then put into the dark by wrapping it in aluminum foil. A syringe wrapped in aluminum foil was used to transfer the reaction mixture in the dark into a stirring solution of hexanes (50 mL, also wrapped in aluminum foil). The white precipitate was decanted, and re-dissolved in dichloromethane before precipitating again into hexanes to yield 280 mg of a white powder. Mₙ=3,300 g/mol, M_{w}/Mₙ=1.33.

### Example 13

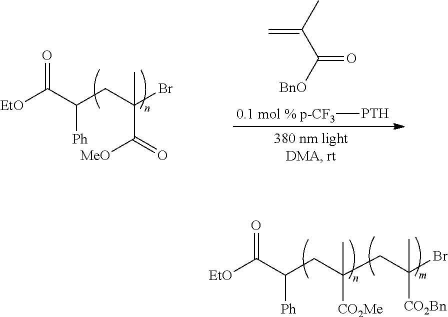

A vial equipped with a magnetic stir bar and fitted with a teflon screw cap septum was charged with benzyl methacrylate (595 μL. 3.51 mmol), p-CF₃-PTH (1.2 mg, 0.1 mol %) and dimethylacetamide (500 μL). In another flask, 500 μL of dimethylacetamide was added to the poly(methyl methacrylate) macroinitiator (49 mg, 0.031 mmol). Both reaction mixtures were degassed with three freeze-pump-thaw cycles. Using a syringe, the monomer and catalyst were then transferred to the flask containing macroinitiator. The reaction was stirred in front of 380 nm LEDs while cooling with compressed air to maintain ambient temperature. After 4 h the reaction was stopped by opening to air and precipitated into MeOH (20 mL). The product was filtered, redissolved in CH₂Cl₂, and precipitated into MeOH again (20 mL). (yield: 201 mg of a white powder) Mₙ=10,800 g/mol, M_{w}/Mₙ=1.44.

### Example 14

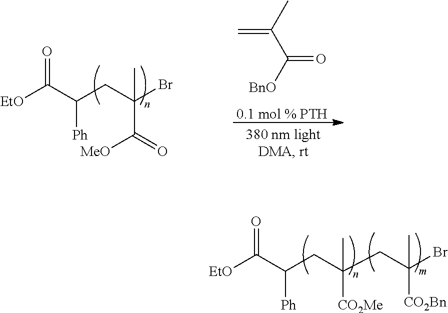

A vial equipped with a magnetic stir bar and fitted with a teflon screw cap septum was charged with benzyl methacrylate (639 μL, 3.77 mmol), PTH (1 mg, 0.1 mol %) and dimethylacetamide (500 μL). In another flask, 500 μL of dimethylacetamide was added to the poly(methyl methacrylate) macroinitiator (86 mg, 0.033 mmol). Both reaction mixtures were degassed with three freeze-pump-thaw cycles. Using a syringe, the monomer and catalyst were then transferred to the flask containing macroinitiator. The reaction was stirred in front of 380 nm LEDs while cooling with compressed air to maintain ambient temperature. After 5.5 h the reaction was stopped by opening to air and precipitated into Hexanes (20 mL). The hexanes was then decanted off and the residual solvent was evaporated before redissolving in CH₂Cl₂. The redissolved polymer was then precipitated into hexanes (20 mL. This process was repeated one more time. (yield: 228 mg of a white powder) Mₙ=10,800 g/mol, M_{w}/Mₙ=1.44.

### Example 15

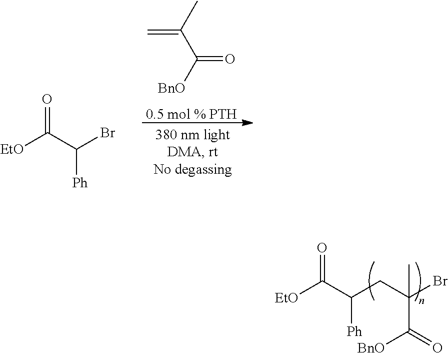

A vial equipped with a magnetic stir bar and fitted with a teflon screw cap septum was charged with benzyl methacrylate (635 μL, 3.75 mmol), photocatalyst (0.5 mol %) and dimethylacetamide (1 mL). The reaction mixture was capped without any degassing precautions taken. Lastly, ethyl α-bromophenylacetate (5.8 μL, 0.033 mmol) was added. The reaction was vigorously stirred in front of 380 nm LEDs while cooling with compressed air to maintain ambient temperature. The reaction was allowed to proceed to ca. 50% conversion of benzyl methacrylate as monitored by ¹H NMR. An aliquot was removed and analyzed by GPO: Mₙ=17,600 g/mol, M_{w}/Mₙ=1.26.

### Example 16

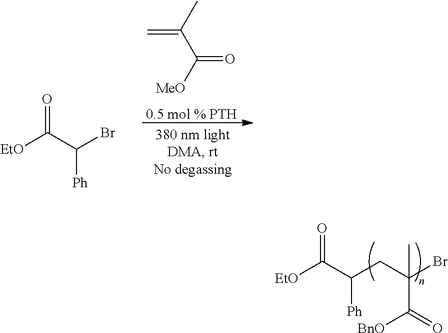

A vial equipped with a magnetic stir bar and fitted with a rubber septum was charged with methyl methacrylate (2.4 mL, 22.5 mmol), 10-phenylphenothiazine (31 mg, 0.5 mol %) and dimethylacetamide (6 mL). The reaction mixture was capped without any degassing precautions taken. Lastly, ethyl α-bromophenylacetate (39 μL, 0.225 mmol) was added. The reaction was stirred in front of 380 nm LEDs while cooling with compressed air to maintain ambient temperature. The reaction was stirred in front of the light for 3.5 h (29% conversion), and stopped by precipitating into hexanes (250 mL). The white precipitate was decanted, and redissolved in dichloromethane before precipitating again into hexanes (250 mL) to yield 517 mg of a white powder. Mₙ=4,200 g/mol, M_{w}/Mₙ=1.12.

### Example 17

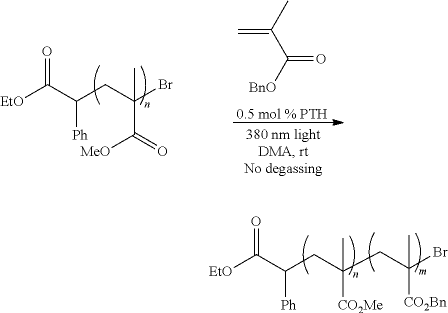

A vial equipped with a magnetic stir bar and fitted with a teflon screw cap septum was charged with benzyl methacrylate (617 μL, 3.64 mmol), PTH (5 mg, 0.5 mol %), poly(methyl methacrylate) macroinitiator (90 mg, 0.0214 mmol), and dimethylacetamide (1 mL). The reaction mixture was capped without any degassing precautions taken. The reaction was stirred in front of 380 nm LEDs while cooling with compressed air to maintain ambient temperature. After 4 h (33% conv.) the reaction was stopped by opening to air and precipitated into methanol (20 mL), The precipitate was filtered and re-dissolved in CH₂Cl₂ before re-precipitating into methanol. The product was analyzed by ¹H NMR and GPC. (yield: 94 mg of a white powder) Mₙ=17,200 g/moI, M_{w}/Mₙ=1.23.

### Example 18

### Patterning with a Photomask

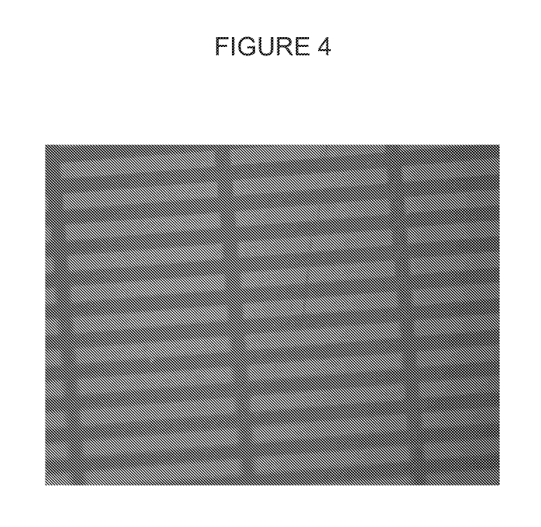

A vial was charged with 1 mg of PTH (0.00375 mmol), 0.1 mL DMA, and degassed. A separate vial was charged with inhibitor-free MMA (400 μL, 3.75 mmol) and degassed. The vials were brought into a nitrogen atmosphere glovebox and combined before the monomer/catalyst solution was pipetted onto a silicon substrate, which had been uniformly functionalized with alkyl bromide initiators, until it was completely covered. A photomask containing transparent rectangles measuring 20 μm×200 μm was then placed on top of the solution to form a thin layer in contact with the substrate. The wafer was placed ca. 3 cm. below the light source and was then irradiated with 380 nm lights. After irradiation, the polymer brush coated substrate was removed from the glove box and washed with dichloromethane before allowing to dry. The rectangular regions of polymer brushes were visualized under an optical microscope, and are illustrated in FIG. 4.

It is understood that the examples and embodiments described herein are for illustrative purposes only and that various modifications or changes in light thereof will be suggested to persons skilled in the art and are to be incorporated within the spirit and purview of this application and scope of the appended claims. All publications, patents, and patent applications cited herein are hereby incorporated herein by reference for all purposes.

1. A method for preparing an acrylic polymer composition, comprising:
combining one or more (meth)acrylate, (meth)acrylamide, (meth)acrylonitrile, styrene, acrylonitrile, vinyl acetate, vinylcarbazole, vinylpyridine, and vinyl chloride monomers with an initiator and an organic photoredox catalyst to obtain a reaction mixture; and
irradiating the reaction mixture with a light source for a period of time;
subsequently protecting the reaction mixture from the light source for a period of time; and
re-exposing the reaction mixture to the light source, wherein the organic photoredox catalyst is reducing in an excited state.

2. A method of claim 1, wherein the organic photoredox catalyst is selected from a phenothiazine derivative, a phenoxazine derivative, a 9,10-dihydroacridine derivative, a carbazole derivative, aryl amine derivatives, diaryl amine derivatives, triaryl amine derivatives, and large pi-extended all carbon derivate.

3. A method of claim 2, wherein the organic photoredox catalyst is a phenothiazine derivative or a phenoxazine derivative.

4. A method of claim 1, wherein the organic photoredox catalyst has the formula A-Z, wherein each A is independently: 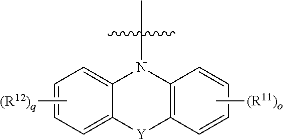
wherein
each Y is independently a bond, O, S, NR¹⁴, or C(R¹⁴)₂;
o and q are independently zero or an integer of 1 to 4;
R¹¹ and R¹² are independently selected from the group consisting of: halogen, cyano, hydroxy, amino, mono or di(C₁-C₂₀)alkylamino, mono or diarylamino, C₁-C₆ alkyl, halo(C₁-C₆)alkyl, C₁-C₆ alkoxy, halo(C₁-C₆)alkoxy, C₃-C₇ cycloalkyl, aryl, aryloxy, alkoxyaryl, and heteroaryl, wherein each alkyl, cycloalkyl, aryl, and heteroaryl group is optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy;
each R¹⁴ is independently hydrogen, C₁-C₆ alkyl, aryl, or aryl(C₁-C₆ alkyl), wherein each alkyl and aryl group is optionally substituted with one or more groups independently selected from C₁-C₆ alkyl, C₁-C₆ alkoxy, halogen, hydroxy, amino, mono- or di-(C₁-C₆) alkylamino, halo(C₁-C₆)alkyl, and halo(C₁-C₆)alkoxy; and each Z is R¹³, —B-(A)₂, —B—(R¹³)₂, —B(A)(R¹³), —NH-(A), —N-(A)₂, —NH—(R¹³), —N—(R¹³)₂, —N(A)(R¹³), —SiR¹³)₃, —SiH(R¹³)₂, —SiH₂(R¹³), —SiH(A)₂, —SiH₂(A), —Si(A)₃, —Si(A)(R¹³)₂, —Si(A)(R¹³)₂, —SiH(A)(R¹³), —PH₂, —P-(A)₂, —P—(R¹³)₂, —P(R¹³)(A), or —P(O)—(OR¹³)₂,
wherein R¹³ is H, C₁-C₂₀ alkyl, —C(O)C₁-C₂₀ alkyl, C₃-C₇ cycloalkyl, aryl, aryl(C₁-C₆ alkyl), heteroaryl, or heteroaryl(C₁-C₆ alkyl), wherein each alkyl, cycloalkyl, aryl, and heteroaryl group is optionally substituted with one or more groups independently selected from C₁-C₆ alkyl, C₁-C₆ alkoxy, halogen, hydroxy, amino, mono- or di- (C₁-C₆) alkylamino, halo(C₁-C₆)alkyl, halo(C₁-C₆)alkoxy, C₃-C₇ cycloalkyl, aryl, aryloxy, alkoxyaryl, heteroaryl, heteroaryloxy, or group A.

5. A method according to claim 1, wherein the organic photoredox catalyst is present at about 0.005 mol % to about 10 mol % relative to the amount of the monomer.

6. A method according to claim 5, wherein the organic photoredox catalyst is present at about 0.05 mol % to about 0.5 mol % relative to the amount of the monomer.

7. A method according to claim 1, wherein the polymerization is carried out in a solvent system, and the solvent system comprises one or more dimethyl formamide, toluene, 1,4-dioxane, xylene, anisole, dimethyl sulfoxide, N,N-dimethylacetamide, tetrahydrofuran, water, methanol, acetonitrile, and chloroform.

8. A method according to claim 1, wherein the concentration of the monomer in the reaction mixture is at least about 1.0 M.

9. A method accordinq to claim 1, wherein the initiator is ethyl 2-bromopropanoate or benzyl 2-bromopropanoate.

10. A method accordinq to claim 1, wherein the monomer is selected from one or more of (meth)acrylic acid, methyl (meth)acrylate, ethyl (meth)acrylate, butyl (meth)acrylate, and styrene.

11. A method according to claim 1, wherein the acrylic polymer is comprised of the same monomer or the acrylic polymer is a block, random, gradient, alternating, brush, or star copolymer comprised of at least two different monomers.

12. A method according to claim 1, wherein the polymerization is carried out under an oxygen-containing atmosphere.

13. A method according to claim 1, wherein the acrylate polymer exhibits a polydispersity of M_{w}/Mₙ between about 1.0 and about 2.5.

14. A method according to claim 1, wherein the organic photoredox catalyst is:

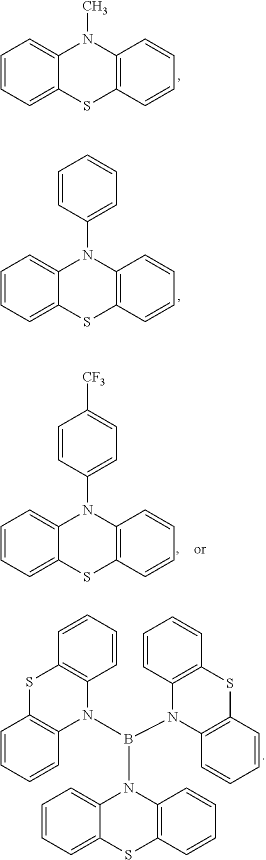

15. A method for preparing an acrylic polymer composition, comprising:
combining one or more (meth)acrylate, (meth)acrylamide, (meth)acrylonitrile, styrene, acrylonitrile, vinyl acetate, vinylcarbazole, vinylpyridine, and vinyl chloride monomers with an initiator and an organic photoredox catalyst to obtain a reaction mixture; and
polymerizing the monomers by irradiating the reaction mixture with a light source; and discontinuing polymerization,
wherein the organic photoredox catalyst is reducing in an excited state.
